(19) United States
(12) Patent Application Publication
(10) Pub. No.: US 2007/0000828 A1
(43) Pub. Date: Jan. 4, 2007

(54) Fluid coupling

(76) Inventors: Wesley Miles Norman, Landenberg, PA (US); Matthew S. Klee, Wilmington, DE (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/174,139

(22) Filed: Jul. 1, 2005

(51) Int. Cl. B01D 15/08; G01F 1/42; F16L 55/00

(52) U.S. Cl. 210/198.2; 285/18; 285/328; 138/44; 422/103

(57) ABSTRACT

A fluid coupling comprises a fitting body, and a chamber within the fitting body, the chamber having at least one fluid conduit receiver bore and a restricted portion, the fluid conduit receiver bore configured to minimize unswept volume in the chamber.

### BACKGROUND

There exist some processes involving flowing gases wherein exclusion of air is important. Such processes might include, for example, semiconductor manufacturing, synthetic chemistry, anaerobic fermentation, and chemical analysis with mass spectrometers, among many other possibilities. In such processes, the ability to disconnect tubing for maintenance, process change, or other operation, without exposing the components or related machinery to air is desired. Air can enter a process through a number of well-known ways including diffusion or through a driving force such as a lower pressure in the process or device compared to the ambient atmospheric pressure. In some processes or instruments, it is desirable to maintain a flow of gas to the process or related instrumentation when the tubing is connected and/or disconnected. This might be required, for example, to maintain continuity in a process variable such as pressure, heat exchange, etc. Maintaining this continuity precludes the use of an on/off valve to prevent the entrance of air when tubing is disconnected. It is also desirable to minimize the volume of a protecting gas necessary to maintain flow to the process and protect against air infiltration.

Many instrumental methods of chemical analysis use one or more sample tubes to collect, concentrate, and transfer sample material to, through, and/or out of the analysis device. The sample tube, sometimes referred to as a capillary tube, or a capillary column, is connected to an analysis device, such as, for example, a gas chromatograph, a mass spectrometer, a detector, and/or to another tube, using a fluid-tight seal. The material that flows through the tube generally includes the mobile phase. In gas chromatography, the mobile phase is referred to as the “carrier gas.” During sample analysis, sample material to be analyzed and carrier gas flow through the tube. Sometimes the tubing through which there is flow has an immobilized or stationary coating on its surface and sometimes the tubing is filled with a packing material. The coating and packing are referred to as a “stationary phase” when their purpose is to effect sample separation. The tube containing the stationary phase is called the “separation column” or simply “the column.”

In chromatography, a sample is introduced into the “flow path” which is a continuous series of sealed connecting tube, fittings, and at least one column. The sample is carried through the flow path by the mobile phase. A sample of material generally comprises a mixture containing a multiplicity of compounds. The purpose of chromatography is to separate components in the mixture such that their identity and/or quantity can be determined. Separation occurs by the differential retardation of sample components as they travel through the column through interaction with the stationary phase. Each sample component will have a characteristic delay between the time it was introduced into the chromatographic system and the time that it is detected after it elutes from the separation column. This characteristic time is called its “retention time.” The larger the difference in retention times between two sample components, the better the ability to accurately determine their identities and/or quantities.

To maximize the efficacy of separation in chromatography, it is also desirable that the separating bands be narrow. The bands appear as peaks on a chromatogram, corresponding to sample components as they travel through the system. One benefit ensuing from narrow bandwidths is increased detectability, also referred to as “sensitivity”. Narrow bands tend to result in higher peaks, which are easier to detect, thereby improving the ability to quantify sample components at low concentrations. Therefore, any action that broadens or distorts the bandwidth or peakshape can negatively impact several aspects of the quality of chromatographic analysis.

Maximum performance of a chromatographic separation is tied to narrow and symmetrical peakshapes. To achieve the best performance, the sample should be introduced as a narrow band or “plug” or the sample should be focused in the system prior to initiating the chromatographic process through the column. Spreading of the bands is sometimes referred to as “band spreading.” Band spreading within chromatographic processes is well known and described in the literature. Excessive band spreading, or that which is introduced over and above chromatographically related band spreading, should be minimized to maximize the accuracy of the analysis. The band spreading that occurs in excess of the normal chromatographic process is often called “extra-column band spreading.”

One common area of extra-column band spreading is in junctions in the sample flow path. An ideal junction imparts no measurable change in peakwidth or shape. A junction with an internal volume that is small relative to the flow rate of the fluid or gas going through it and which has no “dead zones” will minimize distortion and minimize what is referred to as “exponential dilution.” Exponential dilution occurs when a solute band passes through a junction having a volume that is large relative to the band volume, or when there are areas in the junction where there is stagnation in the mobile phase. These areas of stagnation are referred to as “dead zones.” Exponential dilution distorts the band by diluting it in an exponential manner, lowering peak height and imparting an exponential tail to the peak thereby broadening the peak at its base.

In applications in which two tubes are connected together by a fitting, one of the tubes is referred to as an input tube and the other tube is referred to as an output tube. In chromatography, the size of tubes is often small, making the tubes cumbersome to handle. In gas chromatography the tubing is often made of fused silica that is not only small, but also fragile. These factors often work against each other when designing unions to connect tubing in chromatography. To facilitate connecting such tubing, junctions are often designed large enough that they can be easily handled and such that standard tools can be used. Such devices may incorporate a gap as a consequence of their size, or as a purposeful design feature to provide a space between the ends of the input and output tubes to ensure that fragile tubes are not broken upon making connections to the union and/or to allow some flexibility in the precision of tubing position in the junction. Unfortunately, such spaces can then become sources of exponential dilution.

In gas chromatography where tubes are connected to an air sensitive device such as a mass spectrometer, it is desirable both that a junction impart minimal influence on peak shape and also provide a protective barrier to air when one of the tubes is removed.

It is desirable for a number of reasons to minimize the amount of protecting gas necessary to exclude air. It is further desirable to have a union that imparts minimal influence on the shape of chromatographic peaks.

### SUMMARY OF THE INVENTION

According to one embodiment, a fluid coupling comprises a fitting body, and a chamber within the fitting body, the chamber having at least one fluid conduit receiver bore and a restricted portion, the fluid conduit receiver bore configured to minimize unswept volume in the chamber.

Other embodiments of the invention will be discussed with reference to the figures and to the detailed description of the preferred embodiments.

### BRIEF DESCRIPTION OF THE FIGURES

The invention will be described by way of example, in the description of exemplary embodiments, with particular reference to the accompanying figures.

FIG. 1 is a schematic diagram illustrating a simplified chromatograph in which a fluid coupling constructed in accordance with an embodiment of the invention may reside.

FIG. 2 is a schematic diagram illustrating a connector of the fluid coupling of FIG. 1.

FIG. 3 is a schematic diagram illustrating a cross section view of a fluid coupling having a cross-flow restriction and purge capability.

FIG. 4 is a schematic diagram illustrating a cross section view of a straight through fluid coupling.

### DETAILED DESCRIPTION

While described below for use in a gas chromatograph, the fluid coupling to be described below can be used in any analysis application or air-sensitive apparatus where it is desirable to control the flow of a fluid through a small diameter tube and to prevent the infiltration of air into a device when components are connected and disconnected or serviced, without shutting down the device. For example, the fluid coupling is also useful for use in a mass spectrometer or any air sensitive system.

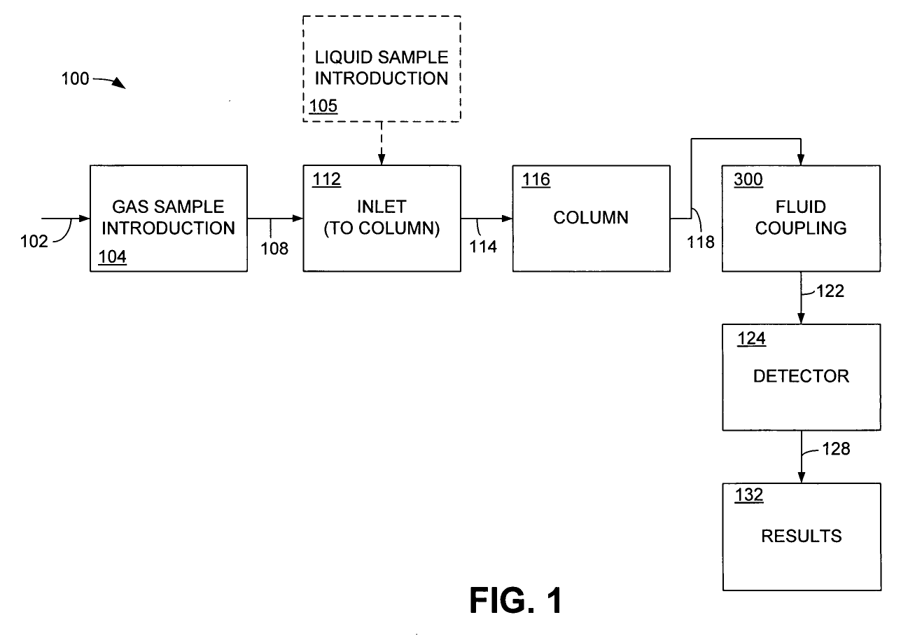

FIG. 1 is a block diagram illustrating a simplified analytical device 100, which is one possible device in which the fluid coupling of the invention may be implemented. In one embodiment, the analytical device may be a gas chromatograph and may include a detector, such as a mass spectrometer. In other embodiments, the analytic device may include a mass spectrometer, without a gas chromatograph. In this example, the analytic device 100 is a gas chromatograph that includes an air-sensitive detector, such as a mass spectrometer. The fluid coupling of the invention may also be used in any gas phase sampling device or in any analytical device, and may also be useful for liquid phase couplings. The fluid coupling can be used to couple two sections of tubing and to restrict the flow of fluid through the tubing. The tubing can be metal, fused silica, and any other small bore, small outer diameter tubing. A fluid connector that can be used with the cross-flow restriction and purge mechanism to be described below is disclosed in co-pending, commonly assigned U.S. patent application Ser. No. 10/924,399, filed on Aug. 23, 2004, entitled “Efficient Fluid Coupling And Method,” attorney docket No. 10040419-1, which is hereby incorporated by reference.

The gas chromatograph 100 includes a means of introducing a sample. A sample can be introduced as a gas via any of several devices known to those skilled in the art. For example, a sample may be introduced via a sample valve 104 which receives a sample of material to be analyzed via connection 102 and provides the sample via connection 108 to, for example, the inlet 112 of a gas chromatograph. Liquid samples can also be introduced in a number of ways. For example, a liquid autosampler 105 might be used to directly introduce a liquid sample into the inlet 112. The inlet 112 is typically connected to a chromatographic column 116. The sample is transferred from the inlet 112 to a chromatographic column 116. The output of the chromatographic column 116 is coupled via connection 118 to a fluid coupling 300 in accordance with an embodiment of the invention. The fluid coupling 300 can be used to couple a capillary tube, such as a chromatographic column 116, or any other tubing to another element within the analytical device 100. In FIG. 1, the fluid coupling 300 is used to couple the chromatographic column 116 to an air-sensitive detector 124, such as a mass spectrometer.

Some of the components of the gas chromatograph are sensitive to air, especially at elevated temperatures. For example, the stationary phase (not shown) inside the chromatographic column 116 can degrade, causing substantive changes in chromatographic behavior. Mass spectrometer performance can be dramatically degraded with air and water ingress. When performing common maintenance on the gas chromatograph and/or air-sensitive detector, it is typical to cool system components to room temperature prior to breaking the seals. It is also common to vent mass spectrometers (turn off pumps such that they return to atmospheric pressure) prior to breaking any gas chromatograph system seals. This is done to avoid exposure of sensitive components to air and moisture at elevated temperatures.

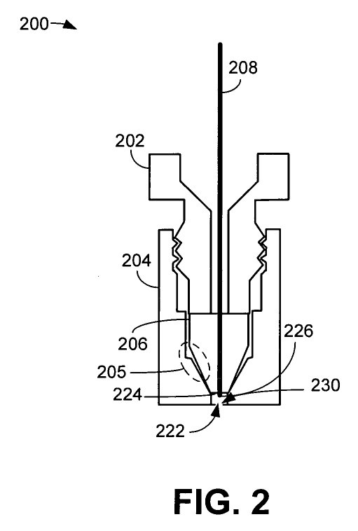

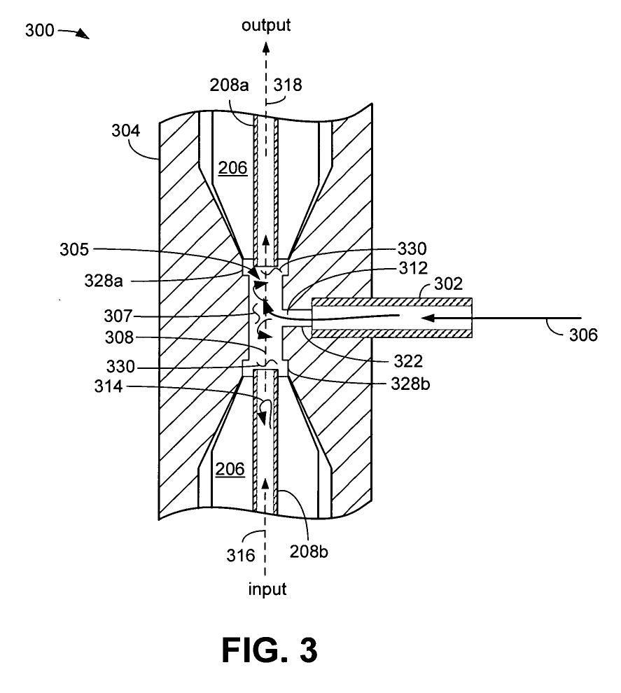

FIG. 2 is a schematic diagram illustrating a fluid connector 200 of the fluid coupling 300 of FIG. 1 and FIG. 3. The fluid connector 200 includes a fitting body 204 having a feature 205. A nut 202 is threaded or otherwise secured into the fitting body 204. The nut 202 abuts and, when tightened, compresses a ferrule 206 into the inner surfaces of the fitting body 204 and the fitting body feature 205. A tube 208, or other type of fluid conduit, passes through the ferrule 206 and can be secured to the inside of the ferrule 206 by, for example, a swage fit, or other connection. The ferrule 206 can be, for example, a metallic component that will not absorb any sample material flowing through the tube 208. The ferrule 206 may be fabricated from a metal such as silver, aluminum, gold, etc. or from a polymeric material, such as polyimide, polyimide/graphite, Teflon, etc. The ferrule 206, when compressed by tightening the nut 202, exerts a downward force and seals a tube 208 against the interior surfaces of the ferrule 206. The fluid connector 200 is designed to mate a tube 208, such as a chromatographic capillary column, to a low-volume diffusion bonded manifold or to another fluidic component, such as that disclosed herein, where it is desirable to mate a tube to a fluidic path while minimizing chromatographic band spreading and the effect of surface activity. The fluid connector 200 can also be implemented in various configurations to allow two or more tubes to be coupled in fluid communication.

The fluid connector 200 is characterized by a minimal void volume, also referred to as the swept volume 230, leading to a conical sealing surface defined by the interior walls of the fitting body 204 and the fitting body feature 205 into which the ferrule 206 is received.

The protrusion of the tube 208 into the swept volume 230 ensures that any material flowing through the tube 208 will not become trapped in the swept volume 230. Any material in the tube 208 will flow through the hole 222 into a mating element. In one embodiment, and as will be described in detail below, the hole 222 forms an entry to a chamber formed by a fitting body designed to couple two or more tubes in fluid communication.

As shown in FIG. 2, the tube 208 extends slightly past the end 224 of the ferrule 206. In a typical installation process, the tube 208 is fitted through the ferrule 206 with a slightly excess length and the ferrule 206 is swaged onto the tube 208. Following this operation, any excess tubing is scored and cut near the ferrule 206, but still leaving a slightly exposed portion 226 extending beyond the end 224 of the ferrule 206. The swaged tube 208, ferrule 206 and nut 202 are inserted into the fitting body 204 and the nut 202 is tightened to develop a semi-permanent seal that may be reused several times.

The swept volume 230 is coupled to a restricted section of the flow path, which will be described below. In one embodiment, the centerline of the tube 208 might be off-center from the hole 222, assuring adequate swirling in the swept volume 230. In another embodiment, the centerline of the tube 208 can be centered with respect to the hole 222. The fluid connector 200 is generally useful for a variety of analysis technologies. For example, the fluid connector 200 is useful in gas chromatography, in which the bandwidth of elutants is not significantly disturbed by the means of material conveyance.

FIG. 3 is a schematic diagram illustrating a cross section view of a portion of a fluid coupling 300 having a cross-flow restriction and purge capability. The fluid coupling 300 comprises a fitting body 304, which is similar to the fitting body 204. However, the fitting body 304 is designed to receive a pair of oppositely oriented ferrules 206 and nuts 202 so that two tubes 208 may be placed in fluid communication while taking advantage of the features of the fluid connector 200 described above.

The tubes 208a and 208b, which in this example are identical though they need not be, extend into a chamber 305 formed within the fitting body 304. The chamber 305 comprises a pair of fluid conduit receiver bores 328a and 328b, and a restricted portion 307, which also forms a fluid switching region. The fluid conduit receiver bores 328a and 328b provide a region 330 into which the protruding ends of the tubes 208a and 208b are received when the tubes 208a and 208b are assembled into the fitting body 304. In one embodiment, the chamber 305 is also in communication with an additional bore 322. A long axis of the additional bore 322 is located substantially parallel to the long axis of the chamber 305.

In accordance with an embodiment of the invention, the diameter of the restricted portion 307 of the chamber 305 is smaller in diameter than the diameter of the fluid conduit receiver bores 328a and 328b. The diameter of the restricted portion 307 of the chamber 305 can be larger, smaller or equal in diameter to the outer diameter of the tube 208. In one embodiment, the diameter of the fluid conduit receiver bores 328a and 328b is approximately 0.8 millimeters. In one embodiment, the outer diameter of the tube 208 is approximately 0.4 to 0.8 millimeters (mm), and in a particular embodiment is approximately 0.5 mm. The dimensions referred to herein are approximate and are illustrated primarily to describe the relative dimensions of the components described. One skilled in the art will recognize that the dimensions are subject to manufacturing tolerances and are intended to be relative. In one embodiment, the diameter of the additional bore 322 is approximately 0.4 mm. In one embodiment, the length of the restricted portion 307 of the chamber 305 is approximately 1.5 mm, the length of the fluid conduit receiver bores 328a and 328b is approximately 0.5 mm and the inner diameter of the restricted portion 307 is approximately 0.5 mm with a tolerance of approximately +/−0.05 mm. Further, the aspect ratio of the length of restricted portion 307 to the diameter of the restricted portion can be approximately 2.5+/−0.6. However, other aspect ratios are possible. Other embodiments of the invention may be implemented in applications in which one of the tubes 208 may be omitted and the fitting body 304 is part of another device or apparatus. In such an implementation, the relative location of the additional bore 322 with respect to the restricted portion 307, and the chamber 305, may differ from that shown in FIG. 3.

The diameter of the fluid conduit receiver bores 328a and 328b being larger than the diameter of the restricted portion 307 eases and facilitates the installation of the tubes 208a and 208b, particularly when the tubes 208a and 208b are fragile. Further, the region 330 provided by the fluid conduit receiver bores 328a and 328b, and the orientation of the ends of the tubes 208a and 208b with respect to the fluid conduit receiver bores 328a and 328b minimizes the unswept volume in the chamber 305 and particularly in the vicinity of the ends of the tubes 208a and 208b, thus minimizing the impact on analysis due to the presence of the fluid coupling 300.

The fluid coupling 300 also includes a cross-flow tube 302 extending substantially perpendicularly into the fitting body 304. The cross-flow tube 302 extends into the fitting body 304 so that it abuts the bore 322. In one embodiment, the inner diameter of the cross-flow tube 302 is 0.5 mm, although other inner and outer diameters are possible.

In this example, an input flow 316 is communicated through the tube 208b and flows into the chamber 305. The normal fluid flow through the chamber 305 is indicated using arrow 308. Under normal flow conditions, the fluid passes through the chamber and enters the tube 208a where it is communicated to the output 318. The direction of fluid flow through the fluid coupling 300 is arbitrary and can be reversed. The design of the chamber 305 minimizes band spreading and exponential dilution of the sample material passing through the chamber 305.

In accordance with an embodiment of the invention, a purge fluid is introduced into the cross-flow tube 302 and is indicated using arrow 306. The purge fluid is chosen depending on the application and depending on the objective and the characteristics of the fluid comprising the fluid flow 308. In one embodiment, the purge fluid can be helium, or another inert fluid. The purge fluid passes through the cross-flow tube 302 and enters the bore 322, indicated at 312. The diameter of the bore 322 is selected so that the velocity of the purge fluid 306 increases as it passes through the bore 322. The purge fluid 306 passes through the bore 322 and enters the restricted portion 307 of the chamber 305.

In one embodiment, the flow 316 from input tube 208b and the flow 306 of the purge fluid from cross-flow tube 302 combine and the total flow is carried out tube 208a as output flow 318. This is a typical scenario where the effluent from a gas chromatograph column is conveyed to a mass spectrometer for detection. The dimensions and relationship of the structural elements of the chamber 305 and the position of the tubes 208a and 208b ensure that solute bandwidth is not significantly degraded (i.e., minimal exponential dilution of the sample material as it traverses through the device).

When the tube 208b is removed, the purge flow 306 is divided and flows toward the output 318 and the input 316. A portion of the purge flow 306 flows out tube 208a and another portion flows out of the opening created when the tube 208b is disconnected from the fitting body 304. The orientation of the long axis of the cross-flow tube 302 and the long axis of the additional bore 322 being substantially perpendicular to the long axis of the restricted portion 307 effectively blocks air from back-diffusing into the restricted portion 307. Due to the efficacy of the design, lower purge flow and pressure are required exclude air from the restricted portion 307 than heretofore possible.

In this manner, the purge fluid acts as a switch, ceasing, or interrupting, the normal fluid flow 308 through the chamber 305. As shown in FIG. 3, while the flow of purge fluid 306 is active, the flow through the input 316 is stopped as indicated by arrow 314. In this manner, a relatively low volume of low pressure fluid flow purges the fluid coupling 300, thus excluding air from the system, and allowing different components to be connected to the fluid coupling 300 without contaminants entering either tube 208a, 208b, or the device to which the tubes are coupled. The fluid coupling 300 can also be used in any air-sensitive system in which it is desirable to prevent the infiltration of air when components are connected and disconnected.

In the fluid coupling 300, the distance from the end of the cross-flow tube 302 that abuts the bore 322 to the entrance of the restricted portion 307 of the chamber 305 should be chosen so that the pressure and flow of the purge fluid 306 is able to effectively exclude air from the chamber 305 when tube 208b is disconnected. In one embodiment, the distance from the end of the cross-flow tube 302 that abuts the bore 322 to the entrance of the restricted portion 307 of the chamber 305 is approximately 0.93 mm.

Further, the dimensions of the chamber 305, the fluid conduit receiver bores 328a and 328b, the additional bore 322 and the switching region 307 ease manufacturing, lower cost, and reduce the risk of contaminants fouling the chamber 305 or the bore 322, and reduce the risk of damage to the fluid coupling 300. In an alternative embodiment, the additional bore 322 and the cross-flow tube 302 can be used to monitor pressure in the chamber 305.

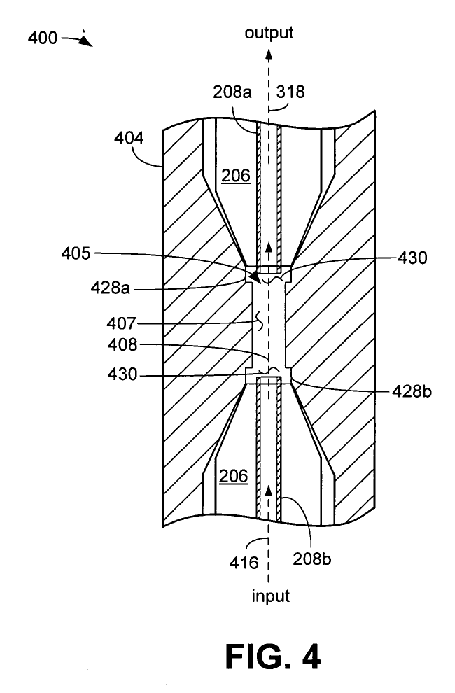

FIG. 4 is a schematic diagram illustrating a cross section view of a portion of a straight through fluid coupling 400. The fluid coupling 400 is similar to the fluid coupling 300 of FIG. 3, but omits the cross-flow tube and additional bore. The fluid coupling 400 comprises a fitting body 404, which is similar to the fitting body 304. The fitting body 404 is designed to receive a pair of oppositely oriented ferrules 206 and nuts 202 so that two tubes 208 may be placed in fluid communication while taking advantage of the features of the fluid connector 200 described above.

The tubes 208a and 208b, which in this example are identical though they need not be, extend into a chamber 405 formed within the fitting body 404. The chamber 405 comprises a pair of fluid conduit receiver bores 428a and 428b, and a restricted portion 407. The fluid conduit receiver bores 428a and 428b provide a region 430 into which the protruding ends of the tubes 208a and 208b are received when the tubes 208a and 208b are assembled into the fitting body 404. In accordance with an embodiment of the invention, the diameter of the restricted portion 407 of the chamber 405 is smaller in diameter than the diameter of the fluid conduit receiver bores 428a and 428b. The diameter of the restricted portion 407 of the chamber 405 can be larger, smaller or equal in diameter to the outer diameter of the tube 208. In one embodiment, the diameter of the fluid conduit receiver bores 328a and 328b is approximately 0.8 mm. In one embodiment, the outer diameter of the tube 208 is approximately 0.4 to 0.8 millimeters (mm), and in a particular embodiment is approximately 0.5 mm. The dimensions referred to herein are approximate and are illustrated primarily to describe the relative dimensions of the components described. One skilled in the art will recognize that the dimensions are subject to manufacturing tolerances and are intended to be relative. In one embodiment, the length of the restricted portion 407 of the chamber 405 is approximately 1.5 mm, the length of the fluid conduit receiver bores 428a and 428b is approximately 0.5 mm and the inner diameter of the restricted portion 407 is approximately 0.5 mm with a tolerance of approximately +/−0.05 mm. Further, the aspect ratio of the length of restricted portion 407 to the diameter of the restricted portion can be approximately 2.5+/−0.6. However, other aspect ratios are possible.

The diameter of the fluid conduit receiver bores 428a and 428b being larger than the diameter of the restricted portion 407 eases and facilitates the installation of the tubes 208a and 208b. Further, the region 430 provided by the fluid conduit receiver bores 428a and 428b, and the orientation of the ends of the tubes 208a and 208b with respect to the fluid conduit receiver bores 428a and 428b minimizes the unswept volume in the chamber 405 and particularly in the vicinity of the ends of the tubes 208a and 208b, thus minimizing the impact on analysis due to the presence of the fluid coupling 400.

The foregoing detailed description has been given for understanding exemplary implementations of the invention and no unnecessary limitations should be understood therefrom as modifications will be obvious to those skilled in the art without departing from the scope of the appended claims and their equivalents. Other devices may use the fluid coupling described herein.

What is claimed is:

1. A fluid coupling, comprising:
a fitting body; and
a chamber within the fitting body, the chamber having at least one fluid conduit receiver bore and a restricted portion, the fluid conduit receiver bore configured to minimize unswept volume in the chamber.

2. The fluid coupling of claim 1, wherein a diameter of the at least one fluid conduit receiver bore is larger than a diameter of the restricted portion.

3. The fluid coupling of claim 2, further comprising at least one fluid tube extending partway into the fluid conduit receiver bore.

4. The fluid coupling of claim 3, further comprising an additional bore in fluid communication with the chamber, the additional bore having a long axis substantially perpendicular to a long axis of the chamber.

5. The fluid coupling of claim 4, further comprising a purge fluid introduced through the additional bore and into the chamber, wherein the purge fluid blocks ingress of air when the at least one fluid tube is disconnected from the fitting body.

6. The fluid coupling of claim 2, wherein the inner diameter of the restricted portion is 0.5 mm+/−0.05 mm.

7. The fluid coupling of claim 6, wherein the aspect ratio of the length of the restricted portion to the diameter of the restricted portion is approximately 2.5+/−0.6.

8. The fluid coupling of claim 7, wherein the length of the restricted portion is at least 1.3 mm.

9. The fluid coupling of claim 3, wherein the at least one fluid tube is part of a chromatographic system.

10. The fluid coupling of claim 3, wherein at least one fluid conduit is part of a mass spectrometer system.

11. The fluid coupling of claim 3, wherein at least one fluid conduit is part of an air-sensitive apparatus.

12. A fluid coupling for an analytical device, comprising:
a fitting body;
a chamber within the fitting body, the chamber having at least one fluid conduit receiver bore and a restricted portion, the fluid conduit receiver bore configured to minimize unswept volume in the chamber, wherein a diameter of the fluid conduit receiver bore is larger than a diameter of the restricted portion;
an additional bore in fluid communication with the chamber, the additional bore having a long axis substantially perpendicular to a long axis of the chamber;
at least two fluid tubes extending partway into respective fluid conduit receiver bores; and
a purge fluid introduced through the additional bore and into the chamber, wherein the purge fluid interrupts the ingress of air into the chamber when one of the fluid tubes is disconnected from the fitting body.

13. The fluid coupling of claim 12, wherein the inner diameter of the restricted portion is 0.5 mm+/−0.05 mm.

14. The fluid coupling of claim 13, wherein the aspect ratio of the length of the restricted portion to the diameter of the restricted portion is approximately 2.5+/−0.6.

15. The fluid coupling of claim 14, wherein the length of the restricted portion is at least 1.3 mm.

16. The fluid coupling of claim 15, wherein at least one fluid tube is part of a chromatographic system.

17. The fluid coupling of claim 15, wherein at least one fluid tube is part of a mass spectrometer system.

18. The fluid coupling of claim 15, wherein at least one fluid conduit is part of an air-sensitive apparatus.

19. A fluid coupling for an analytical device, comprising:
a fitting body;
a chamber within the fitting body, the chamber having at least one fluid conduit receiver bore and a restricted portion, the fluid conduit receiver bore configured to minimize unswept volume in the chamber, wherein a diameter of the fluid conduit receiver bore is larger than a diameter of the restricted portion; and
at least two fluid tubes extending partway into respective fluid conduit receiver bores.

20. The fluid coupling of claim 19, further comprising an additional bore in fluid communication with the chamber, the additional bore having a long axis substantially perpendicular to a long axis of the chamber.
